(19) United States
(12) Patent Application Publication
(10) Pub. No.: US 2013/0171473 A1
(43) Pub. Date: Jul. 4, 2013

(54) METHOD FOR MAKING PATTERNS ON METAL ARTICLE AND THE RESULTING METAL ARTICLE

(71) Applicants: QUAN ZHOU, Shenzhen City (CN); GUI-YUN YANG, Shenzhen City (CN); XIN-WU GUAN, Shenzhen City (CN); PO-FENG HO, Shindian (TW)

(72) Inventors: QUAN ZHOU, Shenzhen City (CN); GUI-YUN YANG, Shenzhen City (CN); XIN-WU GUAN, Shenzhen City (CN); PO-FENG HO, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/571,518

(22) Filed: Aug. 10, 2012

(30) Foreign Application Priority Data
Dec. 30, 2011 (CN) 201110453185.8

(51) Int. Cl. B05D 5/06; B05D 3/12; B32B 15/01; B05D 3/06

(52) U.S. Cl. 428/687; 427/554

(57) ABSTRACT

A method for making patterns on a metal article comprises providing a metal substrate having an outer surface. A light-absorbing coating is formed on selected regions of the outer surface to reduce the surface laser reflectivity of the metal substrate. The selected regions cooperatively have a shape of a desired pattern. The selected regions are treated by laser-quenching, thereby hardening the selected regions. The outer surface is sandblasted, enabling the outer surface besides the selected regions to have a greater surface roughness than the selected regions. A metal article made by the method is also provided.

### BACKGROUND

1. Technical Field

The present disclosure relates to a method for making patterns or logos on metal articles and metal articles made thereby.

2. Description of Related Art

Electronic devices, such as cellular phones often use metal housings. These metal housings are usually decorated with logos or patterns. A method for making these decorations on a metal member includes masking selected regions of the metal member using ink and sandblasting the other unmasked regions. As such, the sandblasted regions have a roughened surface and the masked regions have a smooth surface to form a logo on the metal member. However, masking is a time-consuming process. Moreover, the ink used for a mask may be unfriendly to the environment.

Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings like reference numerals designate corresponding parts throughout the views.

FIG. 1 is a perspective view showing a step of forming a light-absorbing coating on a metal substrate according to an exemplary embodiment of a metal article manufacturing method.

FIG. 2 is a cross-sectional view of a metal article according to an exemplary embodiment.

### DETAILED DESCRIPTION

An exemplary process for making patterns on a metal article may include the following steps.

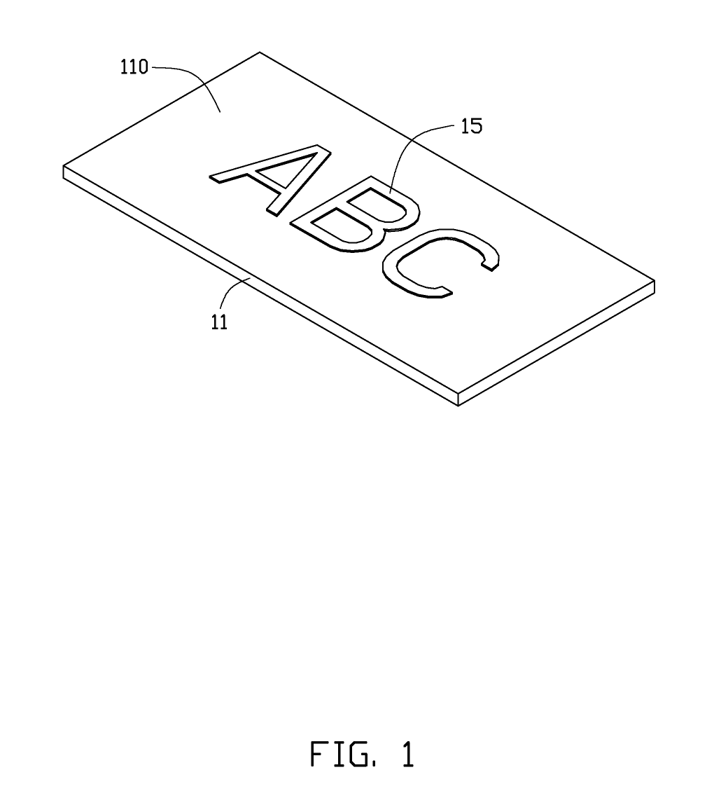

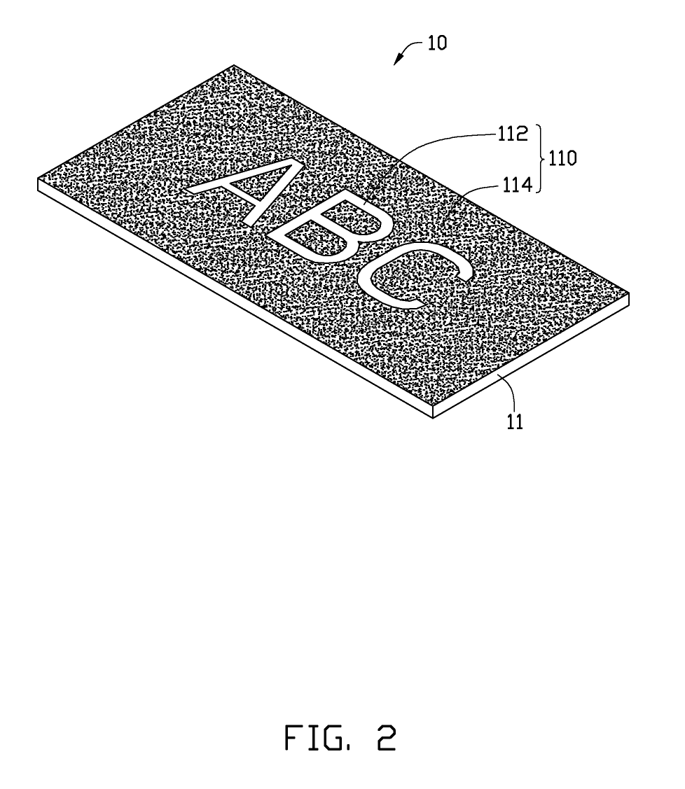

Referring to FIGS. 1 and 2, a metal substrate 11 having an outer surface 110 is provided. The metal substrate 11 is made from carbon-containing iron alloy, such as stainless steel. The metal substrate 11 may have any desired shape.

The metal substrate 11 may be cleaned to remove purities, such as greases. Commercial metal cleaning agents can be used to wash the metal substrate 11.

A light-absorbing coating 15 is coated on selected regions 112 of the outer surface 110. The selected regions 112 cooperatively form a desired pattern. The light-absorbing coating 15 mainly comprises graphite powder, binder, and thinner. The light-absorbing coating 15 is mainly used to reduce the surface laser reflectivity of metal and enable the metal to absorb more laser energy, thereby rapidly heating up the metal under laser radiation and ensuring a good effect in a subsequent laser-quenching process. The light-absorbing coating 15 can disappear after the laser-quenching process.

After the light-absorbing coating 15 is dried, the selected regions 112 coated with the light-absorbing coating 15 are treated by laser-quenching, thereby hardening the selected regions 112. The laser-quenching uses a laser to scan the selected regions 112 to rapidly heat the selected regions 112. Gas (such as inert gas) is blown onto the selected regions 112 to rapidly cool down the selected regions 112 radiated by laser during the laser scanning, preventing the selected regions 112 from melting. The laser-quenching substantially does not change the chemical composition of the metal substrate 11, but causes metal crystalline grains of the selected regions 112 to be smaller than their original size, thereby improving the surface hardness and other mechanical properties of the selected regions 112. By laser-quenching, the selected regions 112 achieve a significantly improved surface hardness which is about 2-3 times the original surface hardness of the selected regions 112. The light-absorbing coating 15 disappears when the laser-quenching is finished.

Referring to FIG. 2, the outer surface 110 is sandblasted. The outer surface 110 besides the selected regions 112 is roughened. Due to having greater hardness, the selected regions 112 are not roughened by the sandblasting and substantially maintain an original surface roughness. By the sandblasting, the arithmetical mean surface roughness (Ra) of the outer surface 110 besides the selected regions 112 may be about 2-3 times the Ra of the selected regions 112. The ten-point mean roughness (Rz) of the outer surface 110 besides the selected regions 112 may be about 3-4 times the Rz of the selected regions 112. That is, the outer surface 110 besides the selected regions 112 has a surface roughness significantly greater than the selected regions 112. As thus, the selected regions 112 form a distinct pattern on the outer surface 110.

FIG. 2 shows a metal article 10 made by the method described above. The metal article 10 may be a housing for an electronic device, such as a mobile phone. The metal article 10 includes the metal substrate 11 having the outer surface 110. The outer surface 110 has selected regions 112 treated by laser-quenching. The selected regions 112 cooperatively have a shape of a desired pattern. The other regions 114 of the outer surface 110 besides the selected regions 112 are sandblasted to be a rough surface. The selected regions 112 have a surface hardness of about 2-3 times the surface hardness of the other regions 114 of the outer surface 110 besides the selected regions 112. The other regions 114 of the outer surface 110 besides the selected regions 112 have a Ra of about 2-3 times the Ra of the selected regions 112. The other regions 114 of the outer surface 110 besides the selected regions 112 have an Rz of about 3-4 times the Ra of the selected regions 112. Thus, the surface roughness of the selected regions 112 is significantly greater than the other regions 114 of the outer surface 110. Therefore the selected regions 112 cooperatively form an obvious metallic pattern on the metal article 10. The selected regions 112 and the other regions 114 of the outer surface 110 have the same chemical composition.

However, even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for making patterns on a metal article, comprising:
providing a metal substrate having an outer surface;
forming a light-absorbing coating on selected regions of the outer surface to reduce the surface laser reflectivity of the metal substrate, the selected regions cooperatively forming a desired pattern;
hardening the selected regions by laser-quenching the selected regions; and
sandblasting the outer surface, enabling the outer surface besides the selected regions to have a greater surface roughness than the selected regions.

2. The method as claimed in claim 1, wherein the light-absorbing coating mainly comprises graphite powder, binder, and thinner.

3. The method as claimed in claim 1, wherein during the laser-quenching, a laser scans the selected regions to rapidly heat the selected regions; gas is blown onto the selected regions to rapidly cool the selected regions radiated by laser during the laser scanning, preventing the selected regions from melting.

4. The method as claimed in claim 1, wherein the laser-quenching causes the selected regions to have a surface hardness of about 2-3 times their original surface hardness.

5. The method as claimed in claim 1, wherein the laser-quenching causes the Ra of the outer surface besides the selected regions is about 2-3 times the Ra of the selected regions; and the laser-quenching causes the Rz of the outer surface besides the selected regions is about 3-4 times the Rz of the selected regions.

6. The method as claimed in claim 1, wherein the metal substrate is made from carbon-containing iron alloy.

7. A metal article, comprising:
a metal substrate having an outer surface, the outer surface having selected regions treated by laser-quenching, the outer regions of the outer surface besides the selected regions sandblasted to be a rough surface, the selected regions having a greater surface hardness than the other regions of the outer surface besides the selected regions, the other regions of the outer surface besides the selected regions having a greater surface roughness than the selected regions.

8. The metal article as claimed in claim 7, wherein the selected regions form a desired pattern.

9. The metal article as claimed in claim 7, wherein the selected regions and the other regions of the outer surface besides the selected regions have the same chemical composition.

10. The metal article as claimed in claim 7, wherein the metal substrate is made from carbon-containing iron alloy.

11. The metal article as claimed in claim 7, wherein the selected regions have a surface hardness of about 2-3 times the original surface hardness of the selected regions.

12. The metal article as claimed in claim 7, wherein the Ra of the outer surface besides the selected regions is about 2-3 times the Ra of the selected regions; the Rz of the outer surface besides the selected regions is about 3-4 times the Rz of the selected regions.
